(19) United States
(12) Patent Application Publication
(10) Pub. No.: US 2018/0270239 A1
(43) Pub. Date: Sep. 20, 2018

(54) SOCIALLY RESPONSIBLE CONTENT ACCESS

(71) Applicant: Altair Engineering, Inc., Troy, MI (US)

(72) Inventors: James R. Scapa, West Bloomfield, MI (US); Stephanie A. Scapa, San Mateo, CA (US)

(21) Appl. No.: 15/920,871

(22) Filed: Mar. 14, 2018

Related U.S. Application Data
(60) Provisional application No. 62/471,486, filed on Mar. 15, 2017.

(51) Int. Cl. H04L 29/06; G06Q 50/00; G06Q 20/02

(52) U.S. Cl. CPC H04L 63/10; G06Q 20/02; G06Q 50/01

(57) ABSTRACT

Socially responsible content access may include receiving, by a server device from a customer device, message data including a request to access content associated with customer account data indicating a customer account. In response to receiving the request to access content, socially responsible content access may include identifying, by the server device, socially responsible content access creator information, wherein the socially responsible content access creator information includes an indication of a content creator associated with the content, accounting, by the server device, for socially responsible content access, and sending, by the server device to the customer device, a response to the request to access content.

### CROSS-REFERENCE TO RELATED APPLICATIONS

This application claims priority of U.S. Provisional Application Ser. No. 62/471,486, filed Mar. 15, 2017. The contents of the prior application is incorporated herein by reference in its entirety.

### TECHNICAL FIELD

The present disclosure relates to apparatuses and methods of access of, and access control for, content, such as digital content, in an electronic computing and communication system.

### BACKGROUND

Digital content, including computer software, music, video, and other digital media, is may be sold or licensed to an end user customer. Accordingly, it may be desirable to provide for socially responsible content access.

### SUMMARY

Disclosed herein are aspects, features, elements, implementations, and embodiments of socially responsible content access.

An aspect of the disclosed implementations a method of socially responsible content access, which may include receiving, by a server device from a customer device, message data including a request to access content associated with customer account data indicating a customer account. Socially responsible content access may include, in response to receiving the request to access content, identifying, by the server device, socially responsible content access creator information, wherein the socially responsible content access creator information includes an indication of a content creator associated with the content, accounting, by the server device, for socially responsible content access, and sending, by the server device to the customer device, a response to the request to access content

Implementations of this aspect can include one or more of the following features.

In some implementations, performing socially responsible content access can include identifying, by the server device, socially responsible content access consumer information associated with the customer account. The socially responsible content access consumer information can indicate a socially responsible content access consent state corresponding to the customer account.

In some implementations, accounting for socially responsible content access can include, on a condition that the socially responsible content access consent state is a positive socially responsible content access consent state, storing data indicating the socially responsible content access.

In some implementations, the method can include receiving, by the server device, a request to modify the socially responsible content access content state corresponding to the customer account, and in response, modifying the socially responsible content access content state corresponding to the customer account.

In some implementations, the response can include socially responsible content access designation information identifying one or more social responsible recipients.

In some implementations, accounting for socially responsible content access can include storing socially responsible content access activity information indicating access to the requested content.

In some implementations, storing the socially responsible content access activity information can include incrementing a counter associated with socially responsible access of the request content.

In some implementations, storing the socially responsible content access activity information can include storing temporal information corresponding to the request to access content.

In some implementations, accounting for socially responsible content access can include providing a resource to the one or more social responsible recipients.

In another aspect, a system includes one or more processors, and a computer-readable medium comprising instructions stored therein, which when executed by the processors, cause the processors to perform operations. The operations include receiving, by a server device from a customer device, message data including a request to access content. The request is associated with customer account data indicating a customer account. The operations also include, in response to receiving the request to access content, performing socially responsible content access. Performing socially responsible content access includes identifying, by the server device, socially responsible content access creator information. The socially responsible content access creator information includes an indication of a content creator associated with the content. Performing socially responsible content access also includes accounting, by the server device, for socially responsible content access. The operations also include sending, by the server device to the customer device, a response to the request to access content.

Implementations of this aspect can include one or more of the following features.

In some implementations, performing socially responsible content access can include identifying, by the server device, socially responsible content access consumer information associated with the customer account. The socially responsible content access consumer information can indicate a socially responsible content access consent state corresponding to the customer account.

In some implementations, accounting for socially responsible content access can include, on a condition that the socially responsible content access consent state is a positive socially responsible content access consent state, storing data indicating the socially responsible content access.

In some implementations, the operations can include receiving, by the server device, a request to modify the socially responsible content access content state corresponding to the customer account, and in response, modifying the socially responsible content access content state corresponding to the customer account.

In some implementations, the response can include socially responsible content access designation information identifying one or more social responsible recipients.

In some implementations, accounting for socially responsible content access can include storing socially responsible content access activity information indicating access to the requested content.

In some implementations, storing the socially responsible content access activity information can include incrementing a counter associated with socially responsible access of the request content.

In some implementations, storing the socially responsible content access activity information can include storing temporal information corresponding to the request to access content.

In some implementations, accounting for socially responsible content access can include providing a resource to the one or more social responsible recipients.

These and other aspects of the present disclosure are disclosed in the following detailed description of the embodiments, the appended claims, and the accompanying figures.

### BRIEF DESCRIPTION OF THE DRAWINGS

The disclosed technology is best understood from the following detailed description when read in conjunction with the accompanying drawings. The various features of the drawings are not to-scale, and the dimensions of the various features may be expanded or reduced for clarity.

FIG. 1 is a diagram of an example of a computing and communication system for socially responsible content access in accordance with embodiments of this disclosure.

FIG. 2 is a flow diagram of a method for socially responsible content access in accordance with embodiments of this disclosure.

FIG. 3 is a flow diagram of a method for socially responsible content access in accordance with embodiments of this disclosure.

FIG. 4 is a diagram of an example of a portion of a user interface socially responsible content access in accordance with embodiments of this disclosure.

### DETAILED DESCRIPTION

A user, or consumer, may access content, such as digital content, via a device, such as a smartphone or a personal computer, which can include using electronic communication networking technology. The use of electronic communication networking technology improves the availability of content for access and allows for enhancements in communication among consumers, creators, providers, and other members of a broad social community associated with the content. The consumers, the creators, the providers, or a combination thereof, may value social responsibility. For example, one or more of the consumers, the creators, and the providers may determine that the value of accessing, using, or consuming content in accordance with social responsibility exceeds the value of accessing, using, or consuming the content independent of social responsibility. However, the availability of accessing, using, or consuming content in accordance with social responsibility may be limited, particularly in the context of an electronic communications network.

Socially responsible content access can provide various technical benefits in the context of an electronic communications network. For example, socially responsible content access may improve the availability of accessing, using, or consuming content on an electronic communications network in accordance with social responsibility by maintaining socially responsible content access information, which may include socially responsible content access designation information, socially responsible content access activity information, or a combination thereof, and communicating the socially responsible content access information to the consumers, the creators, the providers, or a combination thereof. For example, the socially responsible content access designation information may indicate a social responsibility recipient designation associated with the content creator, the socially responsible content access activity information may include information accounting for socially responsible content access, and socially responsible content access may include performing socially responsible activities associated with the designated socially responsible recipient based on the socially responsible content access activity information, such as by providing valuable consideration, which may include donating a portion of proceeds related to the content access, to the designated socially responsible recipient. Accordingly, the implementations of this socially responsible content access can facilitate more effective and efficient communications across an electronic communications network.

The aspects, features, elements, and embodiments of methods, procedures, or algorithms disclosed herein, or any part or parts thereof, may be implemented in a computer program, software, or firmware incorporated in a non-transitory computer-readable storage medium for execution by a computer or processor, such as a special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read-only memories, one or more random access memories, one or more registers, one or more cache memories, one or more semiconductor memory devices, one or more magnetic media, such as internal hard disks and removable disks, one or more magneto-optical media, one or more optical media such as a Compact Disk Read-Only Memory (CD-ROM), and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, images, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content may include any content that may be accessed substantially concurrently with the creation or generation of the content, such as the presentation of a movie in a movie theater, a concert, a sporting event, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, park, venue, museum, or restaurant, or a virtual presentation, such as a broadcast over the Internet or a television broadcast.

As used herein, the terminology “access” or “accessing” may include presenting, downloading, executing, streaming, or otherwise interacting, or enabling interaction, with a digital content object or event. In some embodiments, digital content objects may be executed, stored, or both, at a provider location. In some embodiments, digital content objects may be stored locally on a customer network or a customer device and the digital content objects may be executed or run on the customer network or the customer device.

In some embodiments, socially responsible content access may include unit-based licensing. A creator or owner of content, such as digital content, may control access to the content by licensing the content to end users. For example, licensing may include controlling the right to access content, which may include controlling the right to display, perform, distribute, or reproduce the content. Unit-based licensing may include licensing that controls access to content by allocating licensing units to a customer account, such that one or more licensing units may be redeemed or charged to access one or more events or digital content objects. For example, in some embodiments, a content provider may redeem licensing units and provide content in response to a request for access by a customer.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object, or with a suite of related content objects or events.

As used herein, the terminology “assigned units”, “price”, “licensing price” or variations thereof, may include an assigned number of licensing units that may be exchanged or redeemed to access a particular digital content object or event. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for digital content or events being accessed. “Available units” may refer to a difference between licensed units and checked out units. In some embodiments, licensing units may be temporarily or permanently exchanged for access. Temporarily exchanged licensing units may be returned to the pool of available units associated with the customer upon termination or completion of content access. Returned units may be included in the available units allocated to the customer and may be redeemed for access to digital content or events.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

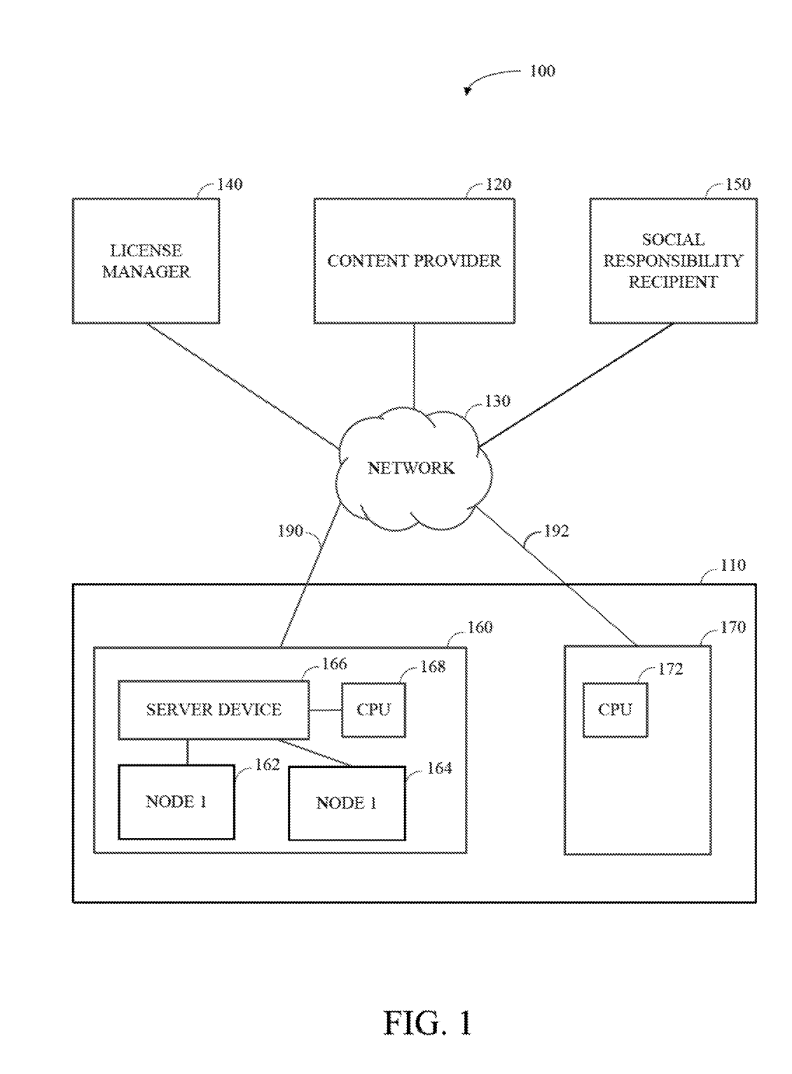

FIG. 1 is a diagram of an example of a computing and communication system 100 for socially responsible content access in accordance with embodiments of this disclosure. For simplicity, the computing and communication system 100 shown in FIG. 1 includes a customer system 110, a provider 120, a communication network 130, a license manager 140, and a social responsibility recipient 150; however, other elements, such as multiple networks, access points, or communication mediums may be included in a communication system for socially responsible content access.

In some embodiments, customer system 110 may be associated with an individual user or customer, and the user may access digital content or events using licensing units allocated to the user or to an account representing the user. In some embodiments, customer system 110 may comprise devices and networks through which a customer or user may access digital content from provider 120, or register for, or access, events. For example, as shown in FIG. 1, customer system 110 may include a customer network 160 and a customer device 170; however, any number of customer networks and customer devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing digital content or events such that members of the group are capable of accessing the digital content or events.

In some embodiments, elements of the customer system 110, such as the customer network 160 and the customer device 170, may communicate with each other or with elements external to the customer system 110, such as the provider 120. For example, the customer network 160 and the customer device 170 may independently communicate through the communication network 130.

In some embodiments, customer network 160 may include one or more individual nodes 162, 164, a server device 166, a host processor 168, or any combination thereof. In some embodiments, the host processor 168 includes a central processing unit (CPU). A node 162, 164 may be a device, such as a computer, and may access digital content. For example, a node 162, 164 may access digital content in response to user input. Although FIG. 1 includes a first node 162 and a second node 164 for simplicity, any number of nodes may be used. In some embodiments, a node 162, 164 may be connected to a server device 166 and may have a unique network address. In some embodiments, a node 162, 164 may communicate with other nodes 162, 164 within customer network 160. The server device 166 may communicate with host processor 168. Although individual nodes 162, 164 are depicted as being connected in a spoke configuration to the server device 166, the individual nodes 162, 164 may be connected in any other electronic computer network configuration. Although shown as separate units, in some embodiments, server device 166 and host processor 168 may be combined into a single device.

In some embodiments, the customer device 170 may be any device, such as a computer or mobile device, capable of accessing digital content. In some embodiments, a customer device 170 may include a processor, such as CPU 172.

In some embodiments, provider 120 may be a device or system configured to provide access to digital content to one or more licensed customers. For example, provider 120 may include an Internet Protocol (IP) network-based unit, such as a website service, that implements methods for controlling access to digital content or events. In some embodiments, provider 120 may provide customer system 110 with access to digital content objects, which may be included in a suite of digital content. In some embodiments, provider 120 may be any system configured to control access to or registration for events by licensed customers. Although FIG. 1 shows the provider 120 as a single unit, the provider 120 may include any number of discrete units and any number of providers 120 may be used.

In some embodiments, the provider 120 may include an event provider (not shown separately) and may control access to or registration for one or more events. The event provider may be any system configured to receive a request to access or register for an event and output a response indicating whether access or registration is granted. In some embodiments, the request for access may include a request to register for the event, which may include receiving registration information. In some embodiments, the event provider may be the provider 120. In some embodiments, event provider may be separate from provider 120. Although shown as a single unit in FIG. 1, in some embodiments, the provider 120 may include a content provider as a first unit and the event provider as a second unit. For example, the content provider and the event provider may be independent units within a single physical device, or may be independent physical devices.

In some implementations, unit-based licensing for digital content may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 160, the customer device 170, or both, may communicate with the communication network 130 via a connection 190, a connection 192, or a combination of the connections 190, 192, which may include one or more wired or wireless connections.

In some embodiments, a license manager 140 may be included in the computing and communication system 100. License manager 140 may control the access to digital content, provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the accessing digital content from provider 120, the termination of the access of digital content, or a change in pricing of digital content being accessed by the customer. In some embodiments, the log may be a file, or database, stored in a memory in communication with provider 120 or license manager 140.

The social responsibility recipient 150 may be an organization, such as a charitable organization, which may communicate with the customer system 110, the provider 120, the license manager 140, or a combination thereof, in association with access to or consumption of content via the computing and communication system 100.

Although not shown in FIG. 1, in some embodiments, the computing and communication system 100 may include a registration unit. In some embodiments, the registration unit may be a device, such as a computer. For example, the registration unit may be a kiosk physically located at an event location. In some embodiments, the registration unit may be configured to receive registration information. For example, the registration unit may include a user interface device, such as a keyboard or touchscreen, and may receive user input indicating registration information via the user input device. In some embodiments, the registration unit may communicate with a user device, such as the customer device 170.

Although not shown separately in FIG. 1, in some embodiments, a device, such as the customer device 170, may access content other than content licensed under unit-based licensing. For example, socially responsible content access may omit unit-based licensing.

In some embodiments, socially responsible content access under unit-based licensing may include controlling access to content in response to a request to access the digital content from a customer system.

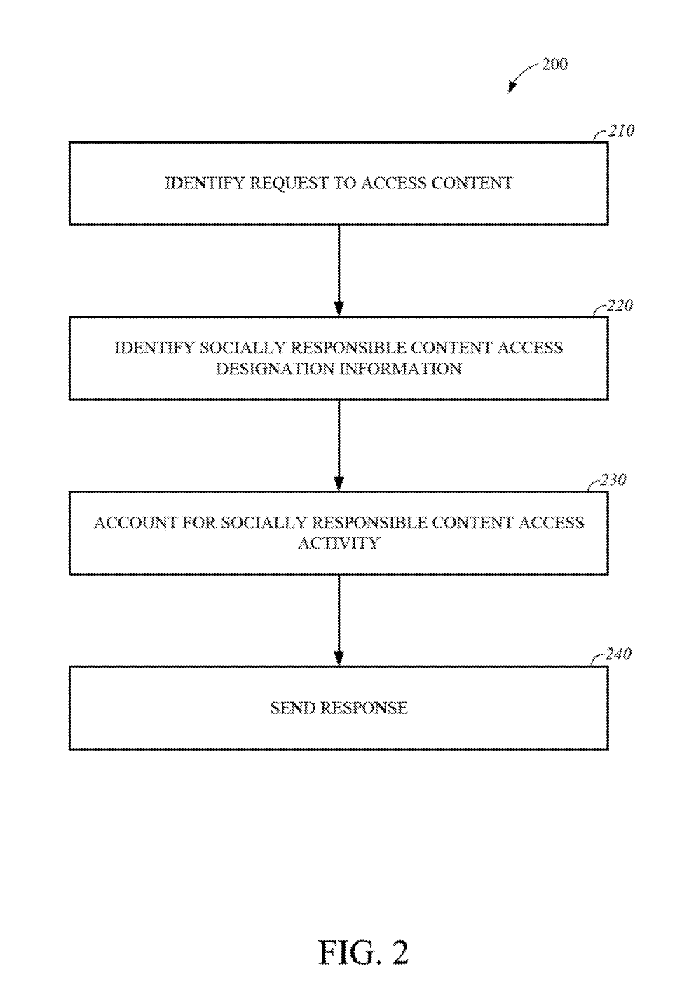

FIG. 2 is a flow diagram of an example of socially responsible content access 200 in accordance with embodiments of this disclosure. Socially responsible content access 200, or a portion thereof, can be implemented one or more devices, such as the customer device 170 shown in FIG. 1, the server device 166 shown in FIG. 1, or a combination thereof.

Socially responsible content access 200 may include identifying a request to access content at 210, identifying socially responsible content access designation information at 220; accounting for socially responsible content access at 230; sending or transmitting a response to the request to access content at 240; or a combination thereof.

A request to access content may be identified at 210. For example, a device, such as the customer device 170, shown in FIG. 1, may receive information indicating a request for content from a user of the device. For example, the device may receive input, such as user input, indicating the request for the content via a user interface presented to the user at the device. The device may transmit the request for the content to an external device, such as the content provider 120, the license manager 140, or both, shown in FIG. 1, which may receive the information, such as message data, indicating the request at 210.

The request may include a customer identifier, which may be associated with a customer account, or any other information capable of uniquely identifying a customer or a user associated with a customer.

The request may include a content identifier, which may uniquely identify the content requested. For example, the request may include a request to access a content object, such as a song or a video, and the content identifier may identify the content object. In another example, the request may include a request to access a content collection, such as an album, a collection of content created by an identified content creator, a playlist, a streaming media station, a collection of content associated with a defined entity, such as a defined social responsibility recipient, and the content identifier may identify the content collection. In some embodiments, a request for content may include an identifier of a content collection and an identifier of a content object associated with the content collection. In some embodiments, a content request may include other information associated with the content or access thereto. For example, the content request may include content access state information, such as a relative temporal location, which may indicate a temporal point for beginning or resuming content access.

Socially responsible content access designation information may be identified at 220. Socially responsible content access designation information may include information designating one or more entities or organizations, such as a charitable organization, an element thereof, or an entity associated therewith, as a social responsibility recipient. For example, identifying the socially responsible content access designation information at 220 may include identifying the content indicated by the content request, identifying a creator of the content, and identifying a social responsibility recipient designated by the content creator. Although described herein with reference to a content creator, a social responsibility recipient may be designated by another entity or organization associated with the content. For example, a content publisher, a content distributor, a content organizer, or a content curator may designate a social responsibility recipient.

In some embodiments, two or more social responsibility recipients may be designated by one or more content creators, or other entities or organizations associated with content. For example, the requested content may be associated with multiple content creators, such as a writer, a director, a performer, or the like, and a respective social responsibility recipient may be designated by one or more of the associated content creators.

In some embodiments, one or more devices, such as a server, of a content provider or a content platform, such as the content provider 120 shown in FIG. 1, the license manager 140 shown in FIG. 1, or a combination thereof, may receive the request for content, identify the content indicated by the request, and identify socially responsible content access designation information associated with the requested content. For example, the server may read or otherwise access the socially responsible content access designation information from a data source, such as a database accessible to the server. In some embodiments, the socially responsible content access designation information may be unavailable, and identifying the socially responsible content access designation information may include generating socially responsible content access designation information indicating the unavailability of the socially responsible content access designation information.

Socially responsible content access activity may be accounted for at 230. Accounting for socially responsible content access activity may include storing or otherwise recording socially responsible content access activity information indicating access to the requested content. For example, one or more devices, such as a server, of a content provider or a content platform, such as the content provider 120 shown in FIG. 1, the license manager 140 shown in FIG. 1, or a combination thereof, may store or otherwise record the socially responsible content access activity information, such as by incrementing a counter associated with socially responsible access of the content. In some embodiments, the server may read or otherwise access the socially responsible content access activity information from a data source, such as a database accessible to the server. In some embodiments, accounting for socially responsible content access activity may include storing temporal information corresponding to the request for access.

In some embodiments, accounting for socially responsible content access activity at 230 may be omitted. For example, the socially responsible content access consumer information may be unavailable and accounting for socially responsible content access activity at 230 may be omitted. In another example, the socially responsible content access designation information may be unavailable and accounting for socially responsible content access activity at 230 may be omitted. In another example, the request for access may be denied and accounting for socially responsible content access activity at 230 may be omitted. Although not shown separately in FIG. 2, in some embodiments, accounting for socially responsible content access activity at 230 may be performed in response to receiving, or otherwise identifying, information reporting or confirming socially responsible content access corresponding to the request for content, which may include information indicating an amount or portion of the content accessed or consumed.

Although not shown separately in FIG. 2, one or more devices, such as a server, of a content provider or a content platform, such as the content provider 120 shown in FIG. 1, the license manager 140 shown in FIG. 1, or a combination thereof, may periodically, such as subsequent to a defined temporal period, such as a year, or in response to an event, such as a change of a social responsibility recipient associated with a content creator, determine an amount of socially responsible content access associated with a content creator, a social responsibility recipient, or both, determine a socially responsible content access value corresponding to the amount of socially responsible content access, and distribute consideration, such as monetary consideration, corresponding to the socially responsible content access value, or a portion thereof, to the social responsibility recipient.

A response to the request to access content may be sent or transmitted at 240. For example, a customer device, such as the customer device 170, shown in FIG. 1, may send the request to access content to one or more devices, such as a server, of a content provider or a content platform, such as the content provider 120 shown in FIG. 1, the license manager 140 shown in FIG. 1, or a combination thereof, at 210, the server may identify socially responsible content access designation information at 220, the server may account for socially responsible content access at 230, and the server may generate and send the response to the customer device at 240.

The response generated and sent at 240 may include one or more of the requested content, content information for the requested content, or the socially responsible content access designation information, or a portion thereof. For example, the socially responsible content access designation information identified at 220 may indicate one or more content creators, or other entities or organizations associated with content, one or more social responsibility recipients designated by the respective content creators, or both.

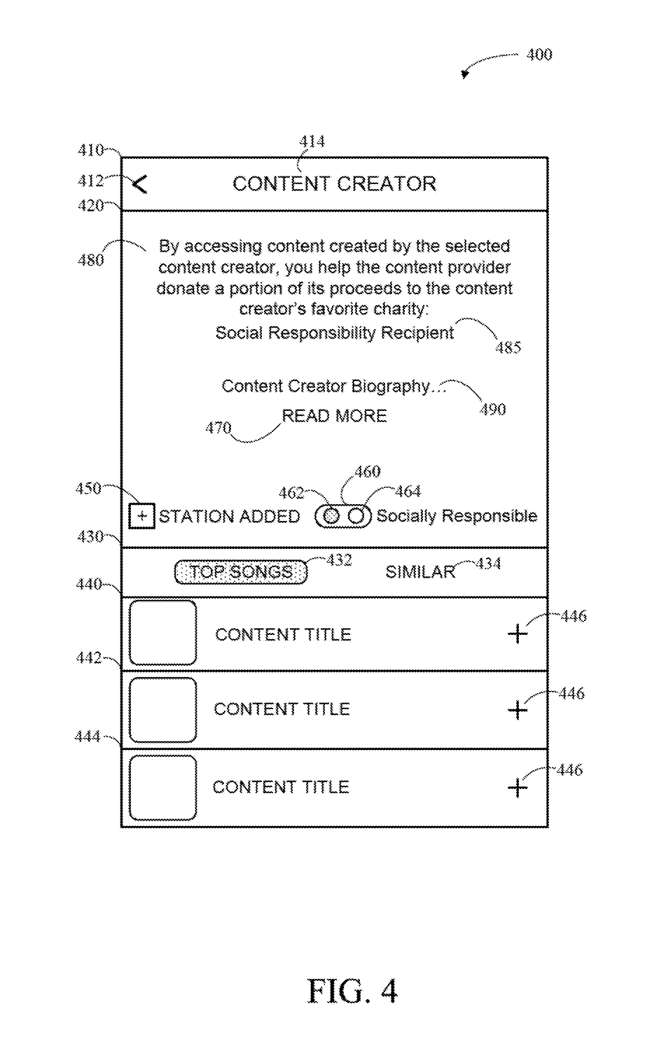

Although not shown separately in FIG. 2, the response, or a portion thereof, may be presented, such as to a user of the customer device as a user interface or a portion thereof. Presenting the response, or a portion thereof, may include presenting the socially responsible content access designation information, or one or more portions, or combinations of portions, thereof, as shown in FIG. 4.

Although not shown separately in FIG. 2, in some embodiments, the server may determine that the request to access content is denied, identifying socially responsible content access designation information at 220, and accounting for socially responsible content access at 230 may be omitted, and sending the response at 240 may include sending an indication that the request is denied.

Although not shown separately in FIG. 2, in some embodiments, socially responsible content access 200 may include using socially responsible content access consumer information. The socially responsible content access consumer information may include consent information, such as consent state information, indicating whether information indicating that a user, customer, or customer account, associated with the request for content has consented to participate in socially responsible content access in association with accessing or consuming the requested content has been identified, received, or stored. In some embodiments, the request for content access may include information received at 210, such as a flag or other value, expressly indicating consent to participate in socially responsible content access in association with accessing or consuming the requested content. In some embodiments, the response sent at 240 may include the socially responsible content access consent state information. In another example, the socially responsible content access consumer information may be unavailable or may indicate a negative consent state, and the response may indicate the negative consent state, may indicate the unavailability of the socially responsible content access consumer information, or may omit the socially responsible content access consumer information.

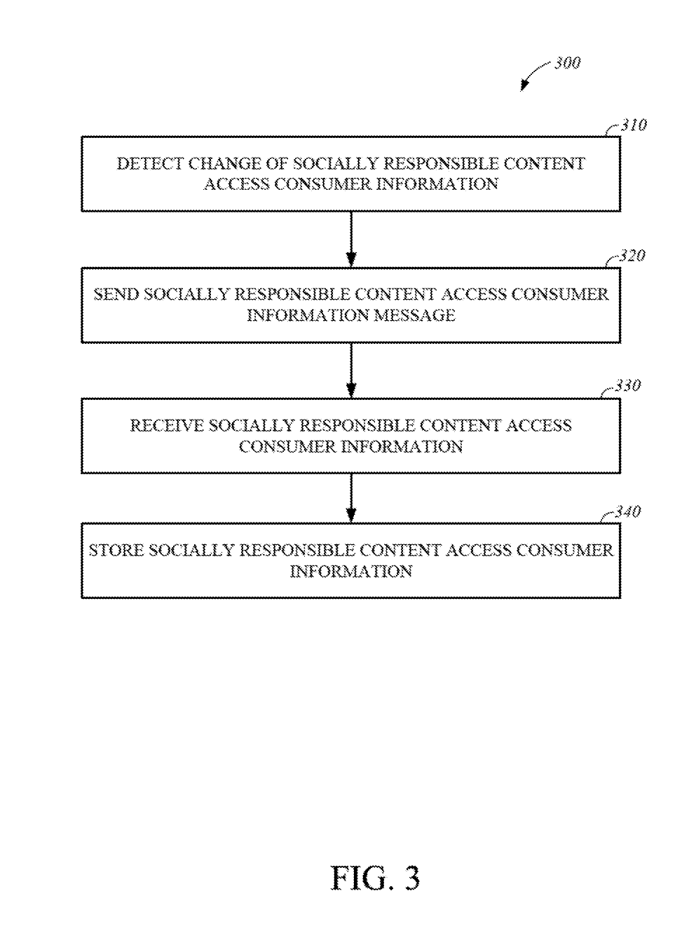

FIG. 3 is a flow diagram of an example of maintaining socially responsible content access consumer information 300 in accordance with embodiments of this disclosure. Maintaining socially responsible content access consumer information 300, or a portion thereof, can be implemented one or more devices, such as the customer device 170 shown in FIG. 1, the server device 166 shown in FIG. 1, or a combination thereof.

In some embodiments, maintaining socially responsible content access consumer information 300 may include detecting a change of socially responsible content access consumer information at 310, sending a socially responsible content access consumer information message at 320, receiving the socially responsible content access consumer information message at 330, storing socially responsible content access consumer information at 340, or a combination thereof.

A change of socially responsible content access consumer information may be detected, or otherwise identified, at 310. For example, a customer device, such as the customer device 170, shown in FIG. 1, may receive information indicating a change of socially responsible content access consumer information from a user of the customer device, which may include an indication a current socially responsible content access consent state for the user. For example, the customer device may receive input, such as user input, indicating the change of socially responsible content access consumer information via a user interface presented to the user at the customer device.

A socially responsible content access consumer information message may be generated and sent at 320. For example, the customer device may generate and send a socially responsible content access consumer information message indicating the change of socially responsible content access consumer information to an external device, such as the content provider 120, the license manager 140, or both, shown in FIG. 1, via a network, such as the network 130 shown in FIG. 1.

The socially responsible content access consumer information message may include a customer identifier, which may be associated with a customer account, or any other information capable of uniquely identifying a customer or a user associated with a customer, such as a user of the customer device. In some embodiments, the socially responsible content access consumer information message may include a content identifier, such as a content identifier associated with defined content, such as content concurrently accessed at or by the customer device. In some embodiments, the socially responsible content access consumer information message may include information identifying a content creator, or other entity or organization associated with the creation, production, management, or distribution of content.

Although not shown separately in FIG. 3, in some embodiments, detecting the change of socially responsible content access consumer information at 310 may be omitted, and the socially responsible content access consumer information message may be generated, sent, or both periodically, or in response to another event. For example, the socially responsible content access consumer information message may be included in a request to access content, such as the request to access content shown at 210 in FIG. 2.

The socially responsible content access consumer information message generated and sent by the customer device at 320 may be received by the server at 330. The server may identify the customer, or an account associated with the customer, indicated by the customer identifier included in the socially responsible content access consumer information message. The server may identify the content creator, or other entity or organization associated with the creation, production, management, or distribution of content, indicated by the socially responsible content access consumer information message. For example, the socially responsible content access consumer information message may include a content identifier, and the server may identify a creator of the content indicated by the content identifier.

The socially responsible content access consumer information may be stored or otherwise recorded at 340. For example, one or more devices, such as the server that received the socially responsible content access consumer information message at 330 may store or otherwise record the socially responsible content access consumer information in a data storage unit, such as a database accessible to the server. In some embodiments, storing the socially responsible content access consumer information may include storing temporal information corresponding to the socially responsible content access consumer information message. Storing the socially responsible content access consumer information may include generating or updating information, such as one or more records, representing an association between the customer, or user, indicated in the socially responsible content access consumer information message and the content creator indicated in the socially responsible content access consumer information message. In some embodiments, storing the socially responsible content access consumer information may include storing an association between the customer, or user, indicated by the socially responsible content access consumer information message and content indicated by the socially responsible content access consumer information message.

FIG. 4 is a diagram of an example of a portion of a user interface 400 for socially responsible content access in accordance with embodiments of this disclosure. In some embodiments, socially responsible content access, such as the socially responsible content access 200 shown in FIG. 2 may include implementing the portion of the user interface 400 shown in FIG. 4. For example, the customer device identifying the request to access content at 210 as shown in FIG. 2 may implement the portion of the user interface 400 shown in FIG. 4. In some embodiments, maintaining socially responsible content access consumer information 300 as shown in FIG. 3 may include implementing the portion of the user interface 400 shown in FIG. 4. For example, the customer device sending a socially responsible content access consumer information message at 320 as shown in FIG. 3 may implement the portion of the user interface 400 shown in FIG. 4.

The portion of the user interface 400 for socially responsible content access shown in FIG. 4 includes include a header portion 410, a primary control portion 420, a secondary control portion 430, one or more content portions 440, 442, 444, or a combination thereof.

The header portion 410 may include one or more control elements 412, such as a back control as shown, one or more information elements 414, or a combination thereof. The information elements 414 may include a representation of an indication of a content creator, or other entity. For example, the information element 414 may include a visual representation of a name or title of the content creator. In some embodiments, presenting the portion of the user interface 400 for socially responsible content access may include maintaining, such as in memory or in a document associated with presenting the portion of the user interface 400 for socially responsible content access, an identifier uniquely identifying the content creator. The content creator identifier may be omitted from the portion of the user interface 400 for socially responsible content access presented.

The primary control portion 420 may include one or more control elements 450, 460, 470, one or more information elements 480, 490, or a combination thereof. In some embodiments, the primary control portion 420 may be visually differentiated from the header portion 410, the secondary control portion 430, or both.

The primary control portion 420 may include a socially responsible content view control element 460. The socially responsible content view control element 460 may include a representation of an indication a current socially responsible content view state for the user interface 400. The socially responsible content view control element 460 may include an overview current socially responsible content view state indicator 462, a detail current socially responsible content view state indicator 464, or both.

The socially responsible content view control element 460 may indicate whether the user interface 400 includes an overview (not shown) associated with the socially responsible content access or includes a detail view (as shown) associated with the socially responsible content access. Although not shown in FIG. 4, an overview associated with the socially responsible content access may include, for example, an image, or other graphical representation, of a content creator, or other entity, associated with the socially responsible content access.

For example, information indicating the current socially responsible content view state may be unavailable or information expressly indicating the overview current socially responsible content view state may be identified and the overview current socially responsible content view state indicator 462 may be graphically emphasized. In another example, information expressly indicating the detail current socially responsible content view state may be identified and the detail current socially responsible content view state indicator 464 may be graphically emphasized.

In response to receiving input, such as user input clicking, tapping, or otherwise interacting with the socially responsible content view control element 460, the socially responsible content view control element 460 may be updated and one or more elements of maintaining socially responsible content access consumer information, such as the maintaining socially responsible content access consumer information 300 shown in FIG. 3, may be performed.

For example, the socially responsible content view control element 460 may indicate the overview current socially responsible content view state, input indicating the detail current socially responsible content view state may be received, the socially responsible content view control element 460 may be updated to indicate the detail current socially responsible content view state, such as by highlighting the detail current socially responsible content view state indicator 464, and the customer device may generate and send a socially responsible content access consumer information message indicating the detail current socially responsible content view state for the corresponding customer or user account and the content creator indicated by the information element 414.

In another example, the socially responsible content view control element 460 may indicate the detail current socially responsible content view state, input indicating the overview current socially responsible content view state may be received, the socially responsible content view control element 460 may be updated to indicate the overview current socially responsible content view state, such as by highlighting the overview current socially responsible content view state indicator 462, and the customer device may generate and send a socially responsible content access consumer information message indicating the overview current socially responsible content view state for the corresponding customer or user account and the content creator indicated by the information element 414.

The primary control portion 420 may include a primary descriptive information element 480. The primary descriptive information element 480 may include a socially responsible content access description. The primary descriptive information element 480 may be generated based on the content creator indicated by the information element 414.

For example, the content creator indicated by the information element 414 may be a musical artist and the primary descriptive information element 480 may omit the text “accessing content created by” and may include the text “listening to”, the primary descriptive information element 480 may omit the text “the selected content creator” and may include a name or title of the content creator indicated by the information element 414, the primary descriptive information element 480 may omit the text “the content provider” and may include a name of the content provider, and the primary descriptive information element 480 may omit the text “the content creator's” and may include other descriptive text, such as “this artist's”.

In another example, the content creator indicated by the information element 414 may be an actor and the primary descriptive information element 480 may omit the text “accessing content created by” and may include the text “watching”, the primary descriptive information element 480 may omit the text “the selected content creator” and may include the text “movies featuring” and a name or title of the content creator indicated by the information element 414, the primary descriptive information element 480 may omit the text “the content provider” and may include a name of the content provider, and the primary descriptive information element 480 may omit the text “the content creator's” and may include other descriptive text, such as “this artist's”.

The primary descriptive information element 480 may include a social responsibility recipient portion 485, which may include a representation of information, such as a name or title, identifying the social responsibility recipient designated by the content creator indicated by the information element 414. For example, the social responsibility recipient may be a charitable organization, and the social responsibility recipient portion 485 may include a representation a name of the charitable organization.

In some embodiments, the social responsibility recipient portion 485 may include a control, such as a hyperlink control, and, in response to identifying input interacting with the social responsibility recipient portion 485, such as by clicking or tapping on the social responsibility recipient portion 485, the customer device may present information corresponding to the social responsibility recipient (not shown).

The primary control portion 420 may include a secondary descriptive information element 490. The secondary descriptive information element 490 may include descriptive information, such as biographical information corresponding to the content creator indicated by the information element 414.

The primary control portion 420 may include a secondary descriptive information control 470 and, in response to identifying input interacting with the secondary descriptive information control 470, such as by clicking or tapping on the secondary descriptive information control 470, the customer device may present information corresponding to the content creator indicated by the information element 414 (not shown).

The secondary control portion 430 may include one or more secondary control elements 432, 434. Each of the content portions 440, 442, 444 may correspond to a content object and may include a representation of information corresponding to the respective content object, such as a name or title of the respective content object, an image associated with the respective content object, or the like, and may include one more control elements 446.

Although not shown separately in FIG. 4, in some embodiments, the user interface 400, such as the primary control portion 420, may include a socially responsible content access consent control element, which may include a representation of an indication a current socially responsible content access consent state for an account, such as an account associated with a user of the portion of the user interface 400, which may correspond to the content creator indicated by the information element 414. The socially responsible content access consent control element may include a negative current socially responsible content access consent state indicator, a positive current socially responsible content access consent state indicator, or both.

The socially responsible content access consent control element may indicate whether information indicating that the user of the portion of the user interface 400 has consented to participate in socially responsible content access in association with accessing or consuming content created by the content creator indicated by the information element 414 has been identified, received, or stored. For example, information indicating the current socially responsible content access consent state may be unavailable or information expressly indicating a negative current socially responsible content access consent state may be identified and the negative current socially responsible content access consent control state indicator may be graphically emphasized. In another example, information expressly indicating a positive current socially responsible content access consent state may be identified and the detail current socially responsible content access consent state indicator may be graphically emphasized.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method comprising:
receiving, by a server device from a customer device, message data including a request to access content, wherein the request is associated with customer account data indicating a customer account;
in response to receiving the request to access content, performing socially responsible content access, wherein performing socially responsible content access includes:
identifying, by the server device, socially responsible content access creator information, wherein the socially responsible content access creator information includes an indication of a content creator associated with the content; and
accounting, by the server device, for socially responsible content access; and
sending, by the server device to the customer device, a response to the request to access content.

2. The method of claim 1, wherein performing socially responsible content access includes:
identifying, by the server device, socially responsible content access consumer information associated with the customer account, wherein the socially responsible content access consumer information indicates a socially responsible content access consent state corresponding to the customer account.

3. The method of claim 2, wherein accounting for socially responsible content access includes:
on a condition that the socially responsible content access consent state is a positive socially responsible content access consent state, storing data indicating the socially responsible content access.

4. The method of claim 2, further comprising:
receiving, by the server device, a request to modify the socially responsible content access content state corresponding to the customer account; and
in response, modifying the socially responsible content access content state corresponding to the customer account.

5. The method of claim 1, wherein the response comprises socially responsible content access designation information identifying one or more social responsible recipients.

6. The method of claim 5, wherein accounting for socially responsible content access comprises storing socially responsible content access activity information indicating access to the requested content.

7. The method of claim 6, wherein storing the socially responsible content access activity information comprises incrementing a counter associated with socially responsible access of the request content.

8. The method of claim 6, wherein storing the socially responsible content access activity information comprises storing temporal information corresponding to the request to access content.

9. The method of claim 5, wherein accounting for socially responsible content access comprises providing a resource to the one or more social responsible recipients.

10. A system comprising:
one or more processors; and
a computer-readable medium comprising instructions stored therein, which when executed by the processors, cause the processors to perform operations comprising:
receiving, by a server device from a customer device, message data including a request to access content, wherein the request is associated with customer account data indicating a customer account;
in response to receiving the request to access content, performing socially responsible content access, wherein performing socially responsible content access includes:
identifying, by the server device, socially responsible content access creator information, wherein the socially responsible content access creator information includes an indication of a content creator associated with the content; and
accounting, by the server device, for socially responsible content access; and
sending, by the server device to the customer device, a response to the request to access content.

11. The system of claim 10, wherein performing socially responsible content access includes:
identifying, by the server device, socially responsible content access consumer information associated with the customer account, wherein the socially responsible content access consumer information indicates a socially responsible content access consent state corresponding to the customer account.

12. The system of claim 11, wherein accounting for socially responsible content access includes:
on a condition that the socially responsible content access consent state is a positive socially responsible content access consent state, storing data indicating the socially responsible content access.

13. The system of claim 10, further comprising:
receiving, by the server device, a request to modify the socially responsible content access content state corresponding to the customer account; and
in response, modifying the socially responsible content access content state corresponding to the customer account.

14. The system of claim 10, wherein the response comprises socially responsible content access designation information identifying one or more social responsible recipients.

15. The system of claim 14, wherein accounting for socially responsible content access comprises storing socially responsible content access activity information indicating access to the requested content.

16. The system of claim 15, wherein storing the socially responsible content access activity information comprises incrementing a counter associated with socially responsible access of the request content.

17. The system of claim 15, wherein storing the socially responsible content access activity information comprises storing temporal information corresponding to the request to access content.

18. The system of claim 14, wherein accounting for socially responsible content access comprises providing a resource to the one or more social responsible recipients.
